(19) United States
(12) Patent Application Publication
(10) Pub. No.: US 2009/0230713 A1
(43) Pub. Date: Sep. 17, 2009

(54) LINK SYSTEM AND METHOD THEREFOR

(75) Inventors: Matthew J. Martin, West Bloomfield, MI (US); Danut P. Tabacaru, Commerce Township, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Edscha North America

(21) Appl. No.: 12/047,890

(22) Filed: Mar. 13, 2008

(51) Int. Cl. B62D 25/12

(52) U.S. Cl. 296/76; 16/221

(57) ABSTRACT

A link system providing a desired spatial relationship in a desired orientation of the link system as well as methods of assembling link systems to obtain the desired spatial relationship. The link system includes at least one rivet deformed during the riveting process to take up the misalignment of apertures in link due to manufacturing tolerance stack up.

### TECHNICAL FIELD

The present disclosure generally relates to link systems and methods of assembling link systems.

### BACKGROUND

Many link systems are assembled from a plurality of mass produced link members pivotally fastened together by pins or rivets. Each link member is manufactured according to certain preset tolerances. As the link members are assembled into a link system, there is a tolerance accumulation, which may result in an undesirable total tolerance stack up between certain locations of the link system, typically the mounting locations, in one or more orientations of the link system.

Such tolerance stack ups may result in an undesirable misfit between mass produced components connected by the link system, which may adversely affect appearance or functionality of the link system itself or that of the finished product into which the link system is assembled. Reduction of this tolerance stack up to within an acceptable range may require that the components be manufactured using more expensive methods or using more expensive equipment than would otherwise be required. Alternatively, this tolerance stack up may be compensated for after assembly, such as by adjustments, requiring extra manufacturing or installation time and expense.

Where the link system is used as a hinge to movably mount a lid to an enclosure, the stack up of tolerances in the link system may result in an undesirable misfit between the lid and the enclosure when the lid is closed. Where the lid is a trunk lid of a vehicle and the enclosure is a trunk enclosure of a vehicle, the tolerance stack up can result in an aesthetically undesirable misalignment of the trunk lid with the outer surfaces of the vehicle. In extreme cases, a tolerance stack up could result in a compromised seal between the trunk and the vehicle, which could potentially result in undesired leakage into the trunk enclosure when the trunk is closed.

### SUMMARY

The present application discloses a link system providing a desired spatial relationship in a desired orientation of the link system as well as methods of assembling link systems to obtain the desired spatial relationship.

In accordance with one exemplary assembly, a link system is disclosed having a plurality of links each one of the link members being pivotally interconnected to at least one of the other link members at a pivot joint. A first chosen link and a second chosen link have a desired relative positional relationship in a specific orientation. At least one of the pivot joints between one of the links and another of the links may include a first aperture in the one of the link members, a second aperture in the another of the link members overlying the first aperture and axially offset relative to the first aperture, and a fastener capable of deformation such as a rivet extending through the first and second apertures. The fastener may have a first head abutting the one link, a first shank portion passing through the first aperture and having a first longitudinal axis and, a second shank portion passing through the second aperture and a having a second longitudinal axis offset relative to the first longitudinal axis, and a second head abutting the another link. The first longitudinal axis may be axially offset from the second longitudinal axis a distance required to position the one link at the desired position relative to the another link in the specific orientation.

In accordance with another exemplary assembly, a method of assembling a link system is provided that may include one or more of the steps of fixturing two selected links to selected relative locations, placing a rivet through a pair of the generally aligned pairs of apertures in two of the links, and compressing (e.g., axially) the rivet to form a head on the backside of the rivet and to deform to conform to the generally aligned apertures to at least partially take up the tolerance stack up between the two selected links.

In accordance with another exemplary assembly, a lid hinge assembly may be provided for movably supporting a lid relative to an enclosure where a desired positional relationship between lid and the enclosure is maintained when the lid is closed. The lid hinge assembly could include a lid link capable of being mounted to the lid, an enclosure link capable of being mounted to the enclosure, and a pair of intermediate links. Each of the intermediate links may have an aperture overlying and axially offset relative to an aperture in the trunk link as well as an apertures overlying and axially offset from an aperture in the lid link. The apertures are axially offset predetermined distances providing the desired positional relationship between the lid link and the enclosure link when the lid link is mounted to the lid, the enclosure link is mounted to the enclosure, and lid is in the closed position. In the example, four rivets each extend through a respective pair of offset apertures, each rivet having a first shank portion passing through a first aperture, a second shank portion offset relative to the first shank portion and passing through a second aperture.

In a further exemplary assembly, a hinge assembly is assembled by fixturing the links of the hinge assembly with two links in a desired relative relationship. To generally align pairs of apertures in associated links, passing at least one rivet having a shank portion with a first outer diameter portion a second shank portion having a second outer diameter portion smaller than the first outer diameter portion through at least one of the pairs of overlying apertures. Then it is possible to deform the at least one rivet to form at least one pivotal connection between the two selected links using the deformed rivet to fill any longitudinal offset between the apertures and compensate for the tolerance stack ups between the links.

The present invention will be more fully understood upon reading the following detailed description in conjunction with the accompanying drawings.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is a perspective view of a motor vehicle having a trunk hingedly supported by an exemplary link system, with a trunk lid shown closed in solid line and open in phantom line, and the link system shown only in the open position in phantom line;

FIG. 2 is a perspective view of the motor vehicle of FIG. 1 with the trunk open, the link system being illustrated in an extended configuration;

FIG. 3 is an elevational view of the link system of FIGS. 1 and 2 with the trunk lid and the a portion of the interior wall of the trunk enclosure shown somewhat schematically in a closed position;

FIG. 4 is an elevational view of the link system of FIGS. 1 and 2 with the trunk lid and the a portion of the interior wall of the trunk enclosure shown somewhat schematically in an open position;

FIG. 5 is an exploded elevational view of the four links of the link system of FIGS. 1-4 shown prior to assembly of the link system;

FIG. 6 is an elevational view of the four links and four rivets of the link system of FIGS. 1-4 fixtured for assembly of the link system, the fixture being shown somewhat schematically;

FIG. 7 is an enlarged elevational view of region 7 of FIG. 6;

FIG. 8 is a sectional view of a representative joint of the link system of FIGS. 1-3 fixtured and prior to riveting of the joint; and

FIG. 9 is a sectional view of the representative joint of FIG. 8 after the riveting of the joint.

### DETAILED DESCRIPTION

Disclosed herein is a link system 20 and method of assembling a link system for providing close dimensional tolerances in a desired orientation of the link system. In the interest of clarity, not all features of an actual implementation of a link system are described in this specification. It will of course be appreciated that in the development of any such actual illustration, numerous implementation-specific decisions must be made to achieve the developers' specific goals, such as compliance with system-related and business-related constraints that will vary from one implementation to another.

Referring now to the drawings wherein like numerals indicate like or corresponding parts throughout the several views, exemplary embodiments of a link system are illustrated.

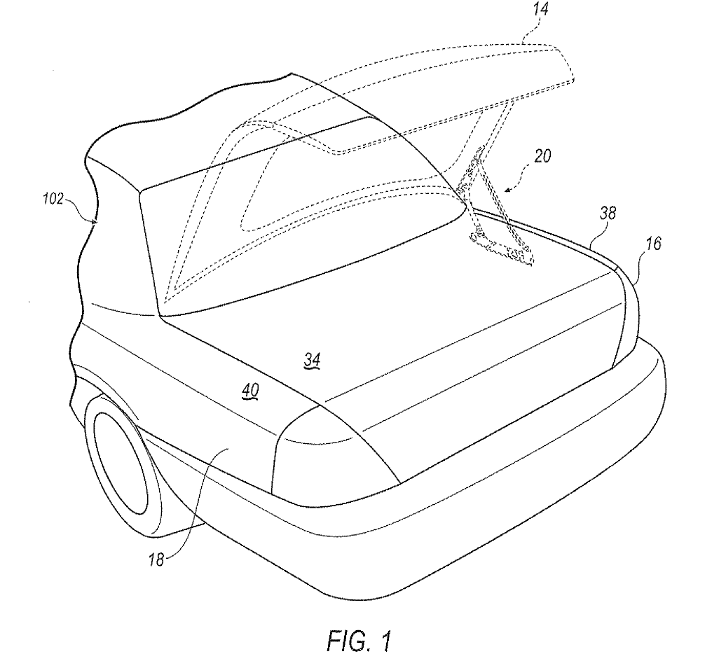

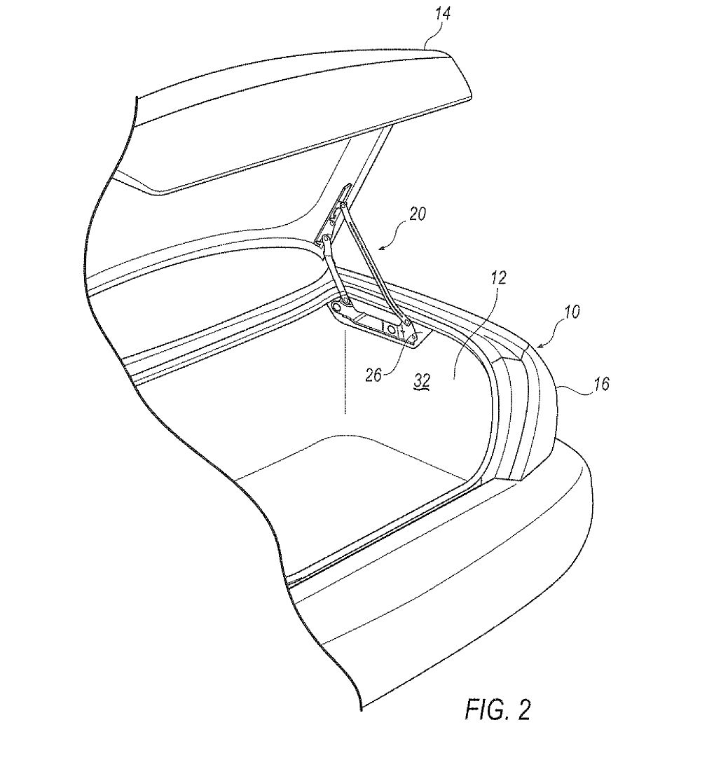

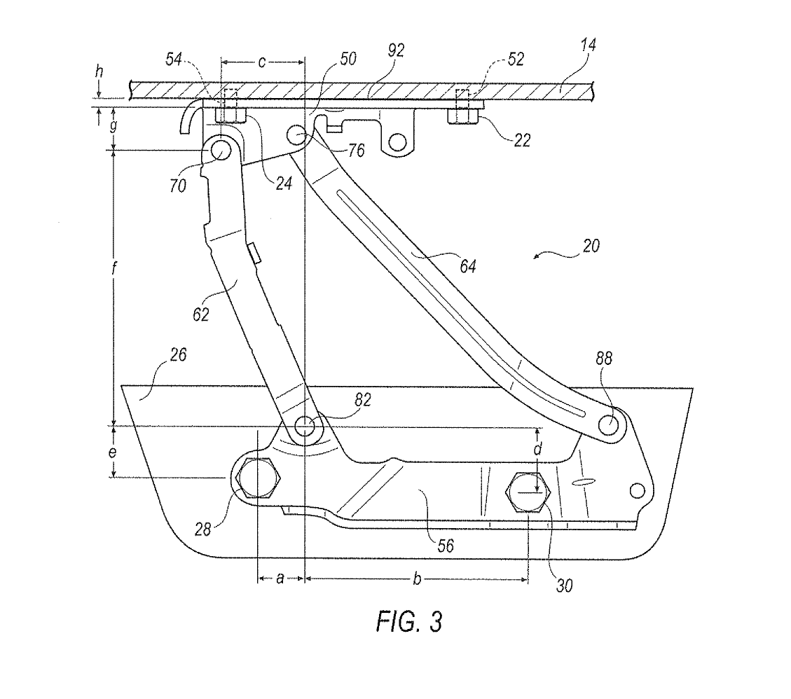

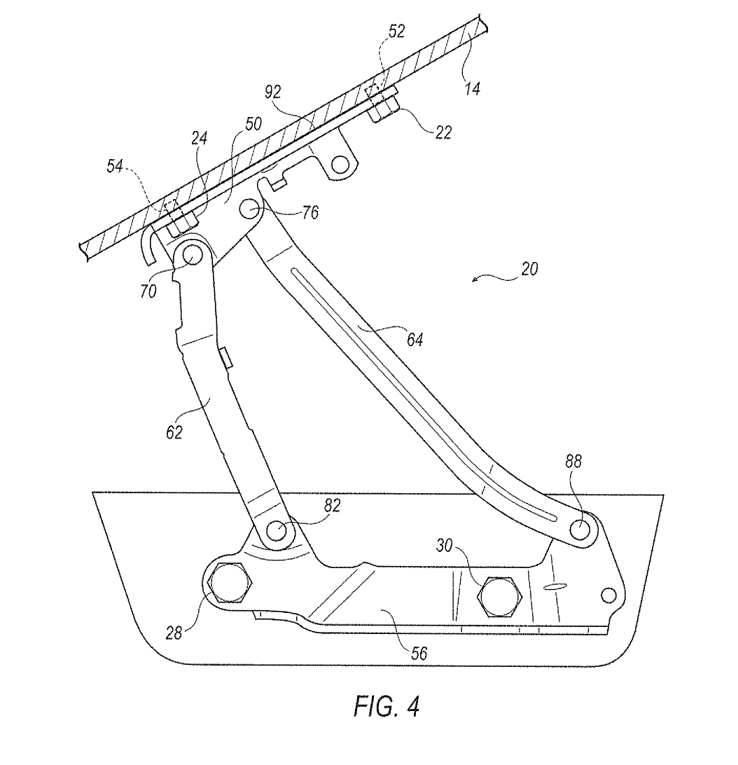

As shown generally in FIGS. 1 through 4, a vehicle 10 has a trunk compartment 12 selectively closed by a trunk lid 14. As best shown in FIG. 1, the vehicle 10 further has a right fender 16 and a left fender 18 (shown only in FIG. 1) on either side of the trunk compartment 12. The trunk lid 14 is hingedly fastened to the vehicle 10 by one or more hinges, such as a link system 20, described later in detail. As best shown in FIGS. 3 and 4, each link system 20 is secured by fasteners 22 and 24 to an inside surface of the trunk lid 14 and by fasteners 28 and 30 to the a mounting surface 26 on the inside of the trunk compartment 12. In the embodiment shown in FIG. 2, the mounting surface 26 is a plate adjacent the inner wall 32 of the trunk compartment 12.

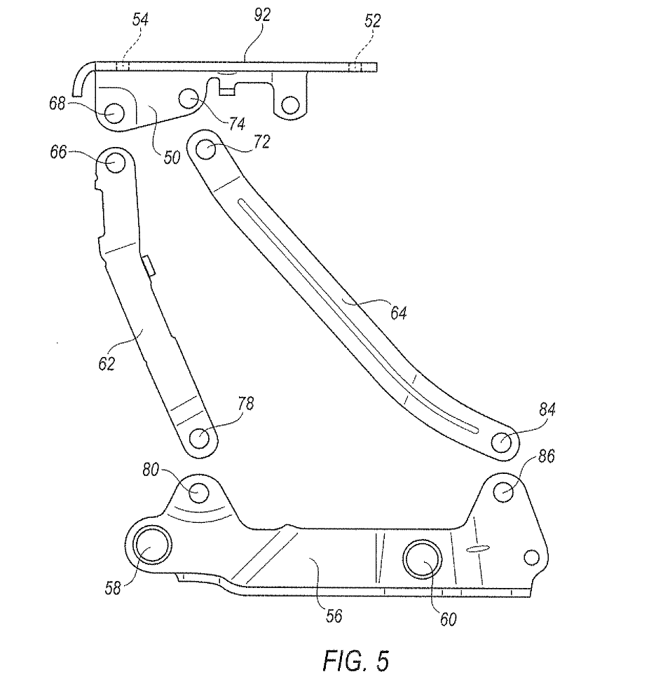

Referring now generally to FIGS. 3 through 5, the link system 20 is shown in a retracted orientation corresponding to the closed trunk in FIG. 3, in an extended orientation corresponding to an open trunk in FIG. 4, and in an exploded view prior to assembly in FIG. 5.

The link system 10 comprises a plurality of links and fasteners that are secured together such as utilizing the exemplary approach described below. In particular, the exemplary link system 20 includes an upper link member 50 having apertures 52 and 54 for accepting the fasteners 22 and 24 (FIGS. 3 and 4) that fasten the link system 20 to the trunk lid 14. The link system 20 further includes a lower link member 56 having apertures 58 and 60 (FIG. 5) for accepting fasteners 28 and 30 (FIGS. 3 and 4) that fasten the link system to the vehicle 10. The link system 20 also includes a first intermediate link member 62 and a second intermediate link member 64, each extending between the upper link member 50 and the lower link member 56. The upper link member 50 and the first intermediate link member 62 are provided with apertures 66 and 68 (shown only in FIG. 5), respectively, proportioned to accept a fastener 70. In an exemplary approach the fastener is capable of selective deformation and is illustrated as a rivet 70 as shown in FIGS. 3 and 4 to pivotally secure the upper link to the first intermediate link. Similarly, the upper link member 50 and the second intermediate link member 62 are provided with apertures 72 and 74, respectively, (shown only in FIG. 5) proportioned to accept a fastener such as a rivet 76 as shown in FIGS. 3 and 4 to pivotally secure the upper link member 50 to the first intermediate link member 62. The lower link member 56 and the first intermediate link member 62 are provided with apertures 78 and 80, (shown only in FIG. 5) respectively, proportioned to accept a fastener such as a rivet 82 to pivotally secure the lower link member 56 to the first intermediate link member 62 as shown in FIGS. 3 and 4. Finally, the lower link member 56 and the second intermediate link member 64 are provided with apertures 84 and 86, respectively, (shown only in FIG. 5) proportioned to accept a fastener such as a rivet 88 to pivotally secure the upper link to the first intermediate link as shown in FIGS. 3 and 4.

There are manufacturing tolerances associated with each of the components of the link system. There are manufacturing tolerances, for example, in the x-axis distance between apertures 58 and 80 (FIG. 5) which are the respective mounting points for fastener 28 and rivet 82 (FIG. 3) of the lower link member 56, shown in FIG. 3 as distance a. There are further manufacturing tolerances in the x-axis distance between apertures 60 and 80 (FIG. 5) which are the respective mounting points for fastener 30 and rivet 82 (FIG. 3) of the lower link member 56, shown in FIG. 3 as distance b. Similarly, there are manufacturing tolerances in the x-axis distance c between apertures 66 and 78 (FIG. 5) of intermediate link member 62 through which rivets 70 and 82 are passed (FIG. 3) is also subject to manufacturing tolerance.

Moreover there is a tolerance stack up in the y-axis direction. For example, y-axis distances d and e of FIG. 3 between apertures 80 for rivet 82 and mounting apertures 56 and 60, respectively, for fasteners 28 and 30 are associated with tolerances in the manufacturing of the lower link member 56. Additional tolerance is associated with the thickness of the material, shown as distance h in FIG. 3, and with the y-axis distance g between surfaces of the upper link member 50 and the center of aperture 68 (FIG. 5) through which rivet 70 is provided. The y-axis distances f between apertures 66 and 78 (FIG. 5) of intermediate link member 62 through which rivets 70 and 82 are passed (FIG. 3) is also subject to manufacturing tolerance. Similarly, the distances between the apertures 72 and 84 of intermediate link member 64, between apertures 68 and 74 of upper link member 50, and between apertures 80 and 86 of lower link member 56 are each subject to a manufacturing tolerance. There are also tolerances associated with the rivets 70, 76, 82 and 88 and further tolerances due to the riveting process. When the link system is assembled, these tolerances may accumulate and each provide an x-axis and y-axis contribution, to a total tolerance stack up between the trunk lid 14 and the vehicle 10, which will differ depending on the orientation of the link assembly.

These tolerances accumulate during the manufacturing and assembly of the link system 20 to result in an unwanted tolerance stack up between the relative location of the apertures 52 and 54 in the upper link member 50 and the apertures 58 and 60 of the lower link member 56. When the link assembly 20 is subsequently assembled to the vehicle 10, this tolerance stack up can result in an undesirable misalignment between the trunk lid 14 and the vehicle 10 in the closed orientation of the trunk lid, unless this tolerance accumulation is accommodated in the manufacturing or assembly process.

More particularly, as shown in FIG. 1 in solid line, when the trunk lid 14 is closed, the upper surface 34 of the trunk lid 14 is disposed adjacent the upper surfaces 38 and 40, respectively, of the right and left fenders 16 and 18. It is desirable for aesthetic, aerodynamic and trunk compartment sealing purposes to position the trunk lid as accurately as possible relative to the fenders 16 and 18 of the vehicle 10. It is therefore desirable to hold the link system 20 to close tolerances. More particularly, it is desired that the tolerance stack up from manufacturing tolerances be minimized or adjusted for in the orientation of the link system corresponding to the closed trunk condition shown in FIG. 3 as the retracted orientation.

On the other hand, as shown in FIG. 1 in phantom line and FIGS. 2 and 4 in solid line, the tolerance stack up in the link system 20 is typically less important when the link system is in the extended position with the trunk lid 14 open relative to the trunk compartment 12. It is therefore desirable to assemble the link system 20 in a manner that holds the assembly of the vehicle 10, trunk lid 14 and link system 20 to close tolerances in the retracted orientation of the link system.

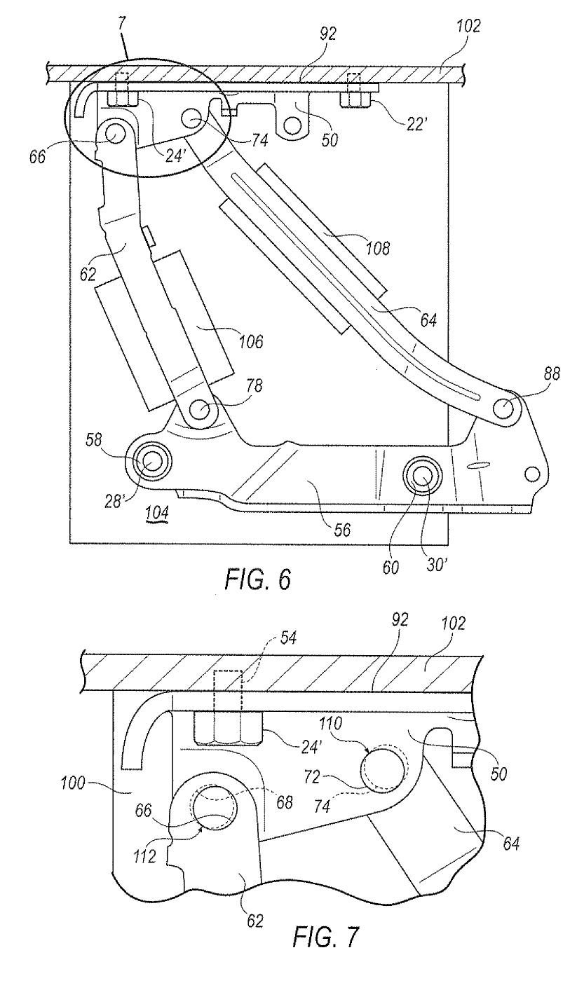

Referring now to FIG. 6 and FIG. 7, components of the link system 20 are shown in a fixture system 100 (shown schematically) for securing the upper link member 50 and the lower link member 56 in temporarily fixed relative locations corresponding to their desired relative locations when assembled. As illustrated, the links are fixtured in a desired position in a desired orientation of the link assembly by being secured at locations corresponding to the mounting locations of the exemplary link system. More particularly, the link assembly illustrated is fixtured in the orientation corresponded to trunk lid 14 being closed, or as close to that position as is reasonably practical, and is fixtured in that position at the mounting locations where the fixture interconnects with the vehicle 10 and the trunk lid 14.

As best shown in FIG. 6, the upper link member 50 is secured in the fixture 100 against a fixturing element 102 that simulates the trunk 14. The upper link member 50 is secured in the selected location by being secured, for example by fasteners 22′ and 24′ in a manner similar to the manner in which it will subsequently be secured to the trunk lid 14 and using the same mounting apertures 52 and 54 which will be used for mounting the upper link member 50 to the trunk lid 14. The fasteners 22′ and 24′ may each include a post extending from the fixturing element through the mounting apertures 52 and 54 and a locking component such as a nut or a pin engaging the post to secure the upper link member 50 in position during assembly. The upper surface 92 of the upper link member 50 may abut the fixturing element 102 in a manner similar to the manner in which the upper link will subsequently abut the trunk lid 14 when the link system 20 is installed in a vehicle 10.

The lower link member 56 is similarly secured to the fixture 100 by being placed adjacent a fixture element 104 having posts 28′ and 30′ which extend through mounting apertures 58 and 60 which will subsequently be used with fasteners 28 and 30 for mounting the lower link member 56 to the vehicle 10. The lower link member 56 may be secured in a position abutting a surface of the fixture element 104 by a locking component (not shown) such as a nut or a pin engaging the posts 28′ and 30′ to secure the upper link member 50 in position during assembly of the link system 20.

The fixture 100 is designed and manufactured to maintain the upper link member 50 and the lower link member 56 their respective desired locations in the preferred orientation corresponding to a closed trunk lid 14. Furthermore, the fixture 100 holds the upper link member 50 and lower link member 56 in these desired locations to within an acceptable tolerance which is smaller than the tolerance stack up inherent in the mass produced components of the link system 20.

Intermediate link member 62 is positioned by fixturing element 106 (shown schematically) to be generally positioned with the apertures 66 and 78 aligned approximately with the apertures 68 and 80, respectively, of the upper link member 50 and the lower link member 56 for subsequent acceptance of rivets. Intermediate link member 64 is similarly positioned by fixturing element 108 (shown schematically) to be generally positioned with the apertures 72 and 84 aligned approximately with the apertures 74 and 86, respectively, of the upper link member 50 and the lower link member 56.

The positioning of the intermediate links 62 and 64 relative to the upper link member 50 and the lower link member 56 is held to a predetermined tolerance, but will not result in perfect alignment of the apertures. Since the upper and lower links 50 and 56 are held in their respective relative desired positions determined by the fixturing elements 102 and 104, respectively, the tolerance stack up that otherwise would accumulate between the mounting location of the upper link member 50, defined by the apertures 52 and 54, and the mounting location of the lower link member 56, defined by the apertures 58 and 60 will be reflected in a slight misalignment between the pairs of overlying apertures in the respective links. This is best shown by way of example at 110 and 112 in FIG. 7.

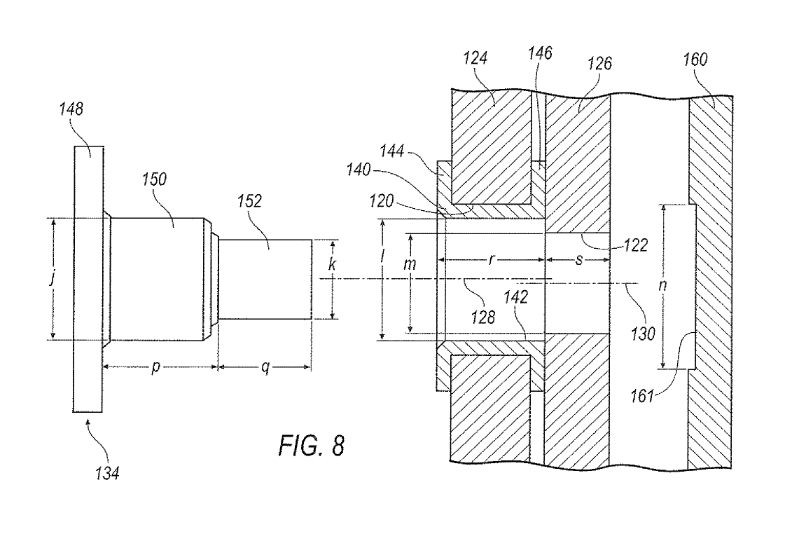

Refer now to FIG. 8, showing a cross-section through a exemplary pair of apertures 120 and 122 in representative links 124 and 126, respectively, illustrative of any or all of the overlying pairs of apertures in the link system 20 described above. The misalignment of overlying apertures resulting from tolerance stack up is illustrated in FIG. 8 by the misalignment of the respective longitudinal axes 128 and 130 of the exemplary apertures 120 and 122. The misalignment of the longitudinal axis is the result of the tolerance stack up described above and is at least partially taken up the riveting process described below.

An exemplary rivet 134 is provided for insertion in the pair of exemplary apertures 120 and 122 for riveting the representative links 124 and 126 together.

A bushing 140 may be fitted in the aperture 120. The busing 140 has an aperture 142 and provides a bearing surface for the exemplary rivet 134 to facilitate the pivotal movement between the representative links 124 and 126 after the components have been riveted together. The bushing 140 also includes outwardly oriented flanges 144 and 146 cooperating with opposing faces of the representative link 124 to secure the bushing to representative link 126. The outwardly oriented flange 146 also provides a bearing surface for the representative link 126, further facilitating the pivotal movement between the representative links 124 and 126 after the components have been riveted together.

The exemplary rivet 134 has a head 148 having an outer diameter substantially larger than the inner diameter of the aperture 142 in the bushing 140 so as to permit the head to abut the surface of the link 124. The exemplary rivet 134 further has a first shank portion 150 having an outer diameter j no greater than the inner diameter l of the aperture 142 in the bushing 140 so that it will pass through the aperture and will permit pivotal movement of the representative link 124. The first shank portion has approximately the same length p as the length r of the aperture 142. The exemplary rivet 134 also has second shank portion 152 having a diameter k no greater than the inner diameter m of the exemplary aperture 122 in the representative link 126 and having a length q significantly greater than the length s of the exemplary aperture 122 to provide extra material for the deformation of the exemplary rivet described below. The diameter k of the second shank portion 152 is illustrated smaller than the diameter j of the first shank portion 150 for reasons that will be described below.

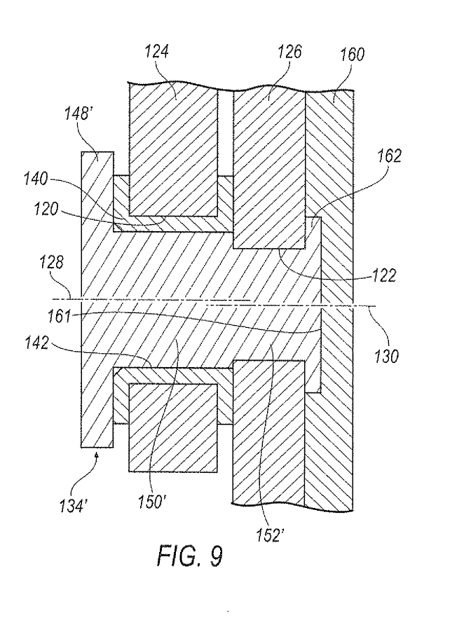

As shown in FIGS. 8 and 9, an anvil 160 is provided on the backside of the exemplary aperture 122 in the representative link 126 for use in the riveting process. The anvil 160 includes a recess 161 having a width n to form a head on the backside of the rivet, as will be described shortly. The anvil 160 may be part of fixture system 100 or may be part of a riveting tool, not shown.

As shown in FIG. 9, illustrating an exemplary pivot joint formed between the representative links 124 and 126 using the exemplary rivet 134, the exemplary rivet is positioned in the apertures 142 and 122 or is driven through the apertures 142 and 122 by a tool, not shown, abutting the head 134. With exemplary rivet 134 secured in position, for example, by a tool, not shown, pushing the head 148 against the representative link 124, the anvil 160 is driven against the second shank portion 152. The shank portion 152 is thereby deformed by pressure into a new configuration shown in FIG. 9 as formed rivet 134′ having a shortened second shank portion 152′ and a second head 162, as described below in detail. The head 148′ is only slightly deformed by the action of the riveting tool and the anvil.

It will be appreciated that for some installations, the anvil 160 may, alternatively, be held in a stationary position against the representative link member 126 and the rivet 134 may be driven through the apertures 142 and 122 and deformed into the recess 161 in the anvil 160 in a single operation.

FIG. 9 illustrates the deformations that occur as the rivet 134 is deformed into formed rivet 134. The portion of the second shank portion 152′ within the exemplary aperture 122 bulges to engage the material of the representative link 126 and deforms eccentrically to accommodate the offset between the longitudinal axes 128 and 130 of the apertures 120 and 122. A portion of the offset of the longitudinal axes 128 and 120 may also be accommodated by asymmetrical deformation of the material of the representative link 126 around the aperture 122, depending on the relative hardness of the components. While the first and second shank portions may have the same outer diameter, the outer diameter k of the second shank portion 152 is illustrated smaller than the outer diameter j of the first shank portion 150 in order to limit the deformation of the first shank portion, which is intended to rotate freely in the bushing 120, while facilitating the deformation of the second shank portion to fill the second aperture 122 to take up at least a portion of the tolerance stack up. By providing the second shank portion with a reduced outer diameter relative to the first shank portion, then, the first shank portion 150′ is also slightly transformed by the riveting tool but remains sufficiently free in the aperture 142 to permit pivoting of the links system 20 about the longitudinal axis 128 of the aperture 142 in the bushing 140 while the second shank portion 152′ is significantly deformed.

As a result of the deformation process conforming the shank portions to the apertures, the formed rivet 134′ will have a first shank portion 150′ with a longitudinal axis 128 offset from the longitudinal axis 130 of the second shank portion 152′. Further, as a result of the deformation process, the formed rivet 134′ and representative links 124 and 126 form a pivot joint for the link system that pivots about longitudinal axis 128.

The portion of the second shank portion 152′ that extends beyond the exemplary aperture 122 is deformed into the recess 161 in the anvil 160 to form a head 162 on the backside of the representative link 126.

Appropriate selection of materials for the bushing 140, the links 124 and 126, and the rivet 134 will facilitate the desired formation of the pivot joint having the characteristics described above. For example, the representative links 124 and 126 and the bushing 140 should be formed of a material that is stronger than the material used for the rivet 134 so that the pressure of the riveting operation will be substantially result in deformation of the rivet rather than the other components of the pivot joint. For many applications, such as the trunk hinge system illustrated in FIGS. 1 through 4, a n appropriate steel, such as 1018, may be used to facilitate deformation and flow of material at the time of riveting, while providing a durable pivot joint for long term use. However, other materials such as lead could be used depending on the loading and the environment experiences by the link system.

Referring again to FIGS. 6 and 7, the process described above may be used for each of the rivets 70, 76, 82 and 88. The links are thereby pivotally connected together maintaining the desired relationship between the upper link member 50 and the lower link member 56 in the desired orientation, with the undesirable portion of tolerance accumulation taken up by the deformation of the rivets, as illustrated by the asymmetrical relationship between the first shank portion 152′ and the second shank portion 154′ created during the riveting process of the exemplary joint of FIG. 9.

More particularly, the manufacturing tolerances described above with reference to FIGS. 3 results in a tolerance stack up that may be at least partially compensated at each of the pivot joints of the link system 20 by using the process described above. When the links 50, 56, 62 and 64 are secured in the fixture 100, the tolerance stack up will result in each of pairs of overlying apertures to be riveted together, such as apertures 66 and 68, to be offset as shown in FIG. 7 at 112 and reflected in the offset longitudinal axes 128 and 130 for the representative pivot joint shown in FIGS. 8 and 9. The offsets of each of the pairs of overlying apertures must together take up the entire tolerance stack up of the components of the link system 20. To do so the rivets 70, 76, 82 and 88 must be able to be inserted into their respective pair of apertures prior to the riveting process, even when the dimensions of the components are at the extremes of the tolerance ranges and the apertures are longitudinally offset by the maximum amount.

This requirement may be satisfied by dimensioning the apertures in the link system 20 so that they will be large enough to pass the rivets 68, 72, 82 and 88 through all of the respective pairs of generally aligned apertures, even at the maximum offset. This may be accomplished, for example, by assuring the inner diameter m (FIG. 8) of the aperture 122 of each representative link member 126 is larger than the outer diameter k of the second shank potion 152 of each rivet 134 by an amount sufficient to assure that the rivets will together take up the entire stack up of tolerances in the manufacture of the components of the link system 20.

It is possible, alternatively, to accomplish the above described dimensional relationship by either modifying the inner diameter of the apertures or by modifying the outer diameter of the rivet. Therefore, this requirement may alternatively be satisfied by dimensioning the rivets 68, 72, 82 and 88 so that the shank portions 150 and 152 will be small enough to pass through the respective pairs of generally aligned apertures even at the maximum offset. This may be accomplished, for example, by assuring the outer diameter k (FIG. 8) of the second shank portion 152 of each rivet is smaller than the inner diameter m of the second aperture 122 of each of the pairs of generally aligned apertures by an amount sufficient to assure that the rivets will together take up the entire stack up of tolerances in the manufacture of the components of the link system 20.

It will be appreciated that the link system 20 and the method of manufacturing the link system 20 provides a precise relative positioning of the trunk lid 14 in a chosen orientation, in this case the orientation where the trunk lid 14 is closed and it is desirable to have a proper alignment of the trunk relative to the fenders 16 and 18 of the vehicle. This is accomplished preferably by fixturing the hinge assembly 20 in the orientation corresponding to the closed trunk lid position with the links that connect to the trunk lid 14 and to the vehicle 10 in the precise relative positions that they will be in when the link system is installed in a vehicle and forming pivot joints between the links of the link system that maintain this precise relationship. It will be appreciated that, as a result of the method used, the tolerance stack up from manufacturing tolerances in the components are fully compensated for in that chosen orientation of the link system. However, in other orientations of the link system 20, such the fully open trunk orientation of FIG. 1. there is no compensation for the tolerance stack up, since there is less concern for the precise positioning of the trunk lid. In fact, since the links of the link system 20 will pivot about longitudinal axes determined by the manner in which the rivets deform while being fixtured in the chosen orientation, the effect of the tolerance stack up in orientations other than the chosen orientation may be amplified. This is acceptable for uses of the link assembly 20 such as that illustrated since there is significantly less concern about the precise positioning of the links or the components, such as the trunk lid, to which the links are attached in orientations other than the chosen orientation.

It should be noted that for some link systems, fixturing in the fully closed position may not be practical for geometric reasons. For example, the apertures for one of the rivets may be blocked by links or other components in the fully closed position. For such link systems, it may be more practical and advantageous to fixture the link system in a position reasonably close to the fully closed position. In one exemplary embodiment, the riveting may occur, for example, with the link system open an amount required by geometric or other considerations, such as approximately 5 degrees away from the fully closed position to facilitate one or more of the riveting operations. While this orientation may result in a small departure from the precision obtainable in the fully closed position, it may, for some applications, still result in a sufficiently accurate positioning of the links for practical purposes. For such applications, the desired orientation for fixturing may not be the most critical orientation of the link system, then, but instead a practical orientation that will deliver a finished link system that is held to a close tolerance in not only the desired orientation but in other orientations.

It should be noted that the selection of the apertures having a bushing or otherwise having a bearing surface for the rivet may determine the direction in which riveting should occur since the bearing surface may best accommodate rotation of the link system if the bearing surface cooperates with a portion of the shank of the rivet that is not significantly deformed. In the exemplary rivet described above, the shank portion 150 furthest from where the head 162 is formed deforms less than the shank portion 152 closer to the head 162. It should further be noted that the selection of which aperture has the bearing surface determines the center of rotation for the relative movement of the two link members associated with the aperture.

For some applications, it is possible that the link assembly 20 will be in a more precise position, even in the open orientation, than would be likely using standard riveting techniques. This is true particularly if the apertures chosen for the bearing surface, and therefore the apertures that define the center of rotation of the link assembly, are optimally selected to reduce the tolerance stack up as the link assembly moves from the fixtured orientation to other orientations. For the link assembly 20 illustrated in FIGS. 1-4, providing the bearing surface on the apertures 68, 74, 80 and 86 in the upper link member 50 and the lower link member 56, respectively, permits the link system to pivot on points more closely tied to the mounting points of the upper and lower link members, as compared to providing the bearing surface on the apertures 66, 72, 78 and 84 in the intermediate link members 62 and 64.

However, it may not be possible or practical, for some applications, to choose the optimum apertures for defining the centers of rotation of the link assembly 20 for a variety of reasons. For some applications, the geometry of the link system 20 may pose challenges for the placement of riveting equipment and thereby may dictate the direction in which a particular rivet will need to be driven. For other applications, economic considerations may lead to a decision to perform all riveting operations through the assembly in the same direction, even where that differs from the choice that would be made to optimize the pivot points of the link assembly.

In those installations where the optimum selection of apertures to define the axis of rotation is chosen, the tolerance stack up may be significantly reduced or eliminated in all orientations of the link system. In those installations where the optimum selection of apertures to define the axis of rotation may not be chosen, the tolerance stack up will still be significantly reduced or eliminated in the orientation in which the link system is fixtured for riveting. However, the tolerance stack up could be amplified in the other orientations. As described above, this may be acceptable for link systems such as those used for trunk assemblies since the positioning of the trunk lid is not as critical when the trunk is opened as when it is closed.

It is to be understood that the above description is intended to be illustrative and not restrictive. Many alternative approaches or applications other than the examples provided would be apparent to those of skill in the art upon reading the above description. For example in the embodiment illustrated in the drawing and described above, the fixturing of the link system 20 is carried out in the orientation of the links corresponding to the trunk being in the fully closed position. For other embodiments, another relative orientation of links may be critical. The scope of the invention should be determined, not with reference to the above description, but should instead be determined with reference to the appended claims, along with the full scope of equivalents to which such claims are entitled. The present embodiments have been particularly shown and described, which are merely illustrative of the best modes. It is anticipated and intended that future developments will occur in the arts discussed herein, and that the disclosed systems and methods will be incorporated into such future examples.

It is intended that the following claims define the scope of the invention and that the method and apparatus within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

In sum, it should be understood that the invention is capable of modification and variation and is limited only by the claims presented below.

What is claimed is:

1. A method of assembling a link system from a plurality of links comprising:
fixturing the plurality of links for assembly into the link system with a first and a second link fixed in selected relative positions in a selected orientation of the link system and with each link having at least one first aperture generally aligned with and overlying at least one second aperture of another link, wherein the axial offset of at least one of the sets of generally aligned first and second apertures is selected to at least partially offset the stack up of tolerances between the first and second link members in the selected relative positions;
placing a fastener through at least one of the sets of generally aligned first and second apertures, the fastener having a first shank portion disposed in the a first aperture of the generally aligned apertures and a second shank portion disposed in the second aperture of the generally aligned apertures; and
compressing the fastener to form a head on the backside of the fastener and to deform at least one of the first and second shank portions to fill the generally aligned apertures, wherein the fastener forms a pivotal joint between two links of the plurality of links that facilitates maintaining the first and second links in the selected relative positions when the assembled link system is in the selected orientation by deforming to take up at least a portion of the tolerance stack up between the first link and the second link in the selected orientation.

2. The method of claim 1 further comprising:
placing a fastener through each of the sets of generally aligned first and second apertures, each fastener having a first shank portion disposed in the respective first aperture of each generally aligned apertures and a second shank portion disposed in the respective second aperture of each generally aligned apertures; and
compressing the fasteners to form heads on the backside of each fastener and to deform at least one of the respective first and second shank portions to fill the respective generally aligned apertures, wherein each fastener forms a pivotal joint between two links of the plurality of links that facilitates maintaining the first and second links in the selected relative positions when the assembled link system is in the selected orientation by deforming to take up at least a portion of the tolerance stack up between the first link and the second link in the selected orientation.

3. The method of claim 2 wherein each of the heads formed on the backside of each fastener is formed on the same side of the link system.

4. The method of claim 1 wherein each first shank portion has a larger diameter than the second shank portion of each set of generally aligned apertures.

5. The method of claim 1 wherein two intermediate links are each riveted to each of the main links to form a four bar linkage.

6. The method of claim 1 wherein the first and second links having mounting locations for mounting the links to structures in a finished product after assembly of the link system and further wherein the step of fixturing comprises positioning the first and second link members in a fixture with the mounting locations in a selected relative positions corresponding to a selected orientation of the first and second link members in a selected orientation of the link system when assembled into the finished product.

7. The method of claim 6 wherein the apertures in the first and second links are provided with bearing surfaces wherein the link system produced by the method pivots about the centers of the apertures in the first and second links

8. The method of claim 1 wherein the first aperture is provided with a bushing.

9. A method of assembling a hinge assembly having a plurality of links each of the links being pivotally connected to at least one other link at a pivot joint, each pivot joint having pairs of generally overlying apertures for accepting fasteners for pivotally interconnecting pairs of links to each other, the method comprising the steps of:
fixturing the links of the hinge assembly to position two selected links fixed in desired relative positions with respect to each other and to position the plurality of links with each of the pairs of generally aligned apertures for each of the pivot joints held in a generally aligned positions, each pair of generally aligned apertures being axially offset by an chosen amount to compensate at least partially for the tolerance stack up in the manufacture of the links and;
passing a fastener through each pair of generally overlying fasteners; and
deforming each fastener to conform to the passageway defined by the pair of generally overlying fasteners and to take up at least a part of the tolerance stack ups between the two selected links in the desired relative positions.

10. A link system comprising:
a plurality of link members each one of the link members being pivotally interconnected to at least one of the other link members at a pivot joint;
a first chosen link member and a second chosen link member having a desired relative positional relationship in a specific orientation;
at least one of the pivot joints between one of the link members and another of the link members further comprising:
a first aperture in the one of the link members;
a second aperture in the another of the link members overlying the first aperture and axially offset relative to the first aperture;
a fastener extending through the first and second apertures, the fastener having a first end abutting the one link, a first shank portion passing through the first aperture and having a first longitudinal axis and, a second shank portion passing through the second aperture and a having a second longitudinal axis offset relative to the first longitudinal axis, and a second end abutting the another link;
wherein the first longitudinal axis is axially offset from the second longitudinal axis a distance required to position the one link at the desired position relative to the another link in the specific orientation.

11. The link system of claim 10, wherein the one of the one link member and the another link member is provided with a bushing, an one of the first and second apertures is an aperture through the bushing, wherein the bushing provides a bearing surface between the fastener and the one of the first and second links, the bearing surface facilitating relative pivotal motion between the one of the first and second links and the bushing.

12. The link system of claim 11, wherein the one link member is provided with the bushing and the first aperture is through the bushing.

13. The link system of claim 11, wherein the bushing further comprises an annular flange providing a flat bearing surface between the facilitating relative pivotal movement between the one of the link members and the another of the link members.

14. The link system of claim 10 wherein the first aperture is larger than the second aperture.

15. The link system of claim 10 wherein the first shank portion is larger than the second shank portion.

16. The link system of claim 10 wherein the second shank portion has an outer diameter smaller than the inner diameter of the second aperture by an amount selected to take up at least a portion of the tolerance stack up.

17. The link system of claim 10 wherein the desired positional relationship is defined by the relative positions of two selected mounting locations on the first link and two selected mounting locations on the third link when the link system is in the desired relative orientation of the links.

18. The link system of claim 17 wherein the selected mounting locations are the same mounting locations that are provided on the link system for installation of the link system in a finished product assembly.

19. The link system of claim 10 wherein one of the first and second apertures is provided with a bushing having an aperture larger than the other of the first and second apertures.

20. The link system of claim 10 wherein each of the pivot joints between one of the link members and another of the link members comprises:
a first aperture in the one link member;
a second aperture in the another link member overlying the first aperture and axially offset relative to the first aperture; and
a plurality of fasteners, each of the plurality of fasteners extending through a respective first aperture and second aperture, each fastener having a first end abutting a link, a first shank portion passing through a first apertures, a second shank portion passing through a respective second aperture, and a second end abutting a link; wherein the first and second shank portions of each fastener are axially offset in amounts to cumulatively position the first link at the desired position relative to the third link in the specific orientation.

21. A lid hinge assembly for movably supporting a lid relative to an enclosure and having a desired positional relationship between lid and the enclosure when the lid is closed, the lid hinge assembly comprising:
a lid link capable of being mounted to the lid and having two apertures;
an enclosure link capable of being mounted to the enclosure and having two apertures;
a pair of intermediate links each having an aperture overlying and axially offset relative to one of the apertures in the lid link and each having another aperture overlying and axially offset relative to one of the apertures in the enclosure link; wherein the apertures are axially offset predetermined distances providing the desired positional relationship between the lid link and the enclosure link when the lid link is mounted to the lid, the enclosure link is mounted to the enclosure, and lid is in the closed position; and
four rivets each extending through a respective pair of offset apertures, each rivet having a first shank portion passing through a first aperture, a second shank portion offset relative to the first shank portion and passing through a second aperture.

22. The lid hinge assembly of claim 21 wherein:
the enclosure has at least one enclosure surface;
the lid has at least one lid surface adjacent the at least one enclosure surface; and
the desired positional relationship is defined to provide an alignment between the at least one enclosure surface and the at least one lid surface.

23. The hinge lid assembly of claim 21 wherein the enclosure is a vehicle trunk and the lid is a trunk lid.

24. The hinge lid assembly of claim 21 wherein the desired positional relationship is defined by the positions of two selected mounting locations on the enclosure link and two selected mounting locations on the lid link when the link system is in the orientation which it is designed to be in when the lid link is mounted to the lid, the enclosure link is mounted to the enclosure, and lid is in the closed position.

25. The hinge lid assembly of claim 20 wherein the apertures in the lid link and the enclosure link are provided with bearing surfaces wherein the link assembly pivots about the centers of the apertures in the lid link and the enclosure link.
